(19) United States
(12) Patent Application Publication
(10) Pub. No.: US 2026/0018332 A1
(43) Pub. Date: Jan. 15, 2026

(54) INJECTION-MOLDING-TYPE MAGNETIC FIELD SHIELDING MEMBER AND WIRELESS POWER RECEPTION MODULE COMPRISING SAME

(71) Applicant: AMOSENSE CO.,LTD, Cheonan-si, Chungcheongnam-do (KR)

(72) Inventor: Kil-Jae JANG, Cheonan-si, Chungcheongnam-do (KR)

(21) Appl. No.: 18/992,561

(22) PCT Filed: Jul. 3, 2023
(86) PCT No.: PCT/KR2023/009320

§ 371 Date: Jan. 17, 2025

(30) Foreign Application Priority Data
Jul. 8, 2022 (KR) 10-2022-0084281

(51) Int. Cl. H01F 27/36; H01F 1/03; H02J 50/70; H02J 50/90

(52) U.S. Cl. CPC H01F 27/366; H01F 1/0315; H02J 50/70; H02J 50/90

(57) ABSTRACT

An injection-molding-type magnetic field shielding member is provided. The injection-molding-type magnetic field shielding member according to one embodiment of the present invention comprises: a base part including an arrangement hole that penetrates the center so as to have a predetermined area; a ring-shaped first shielding part, which protrudes a predetermined height from the base part along the edge of the arrangement hole; and an antenna accommodation part which is defined by one surface of the first shielding part and one surface of the base part, and which is formed on the one surface of the base part in the circumferential direction of the first shielding part, wherein the base part and the first shielding part can be integrated through injection molding by using any one material from among ferrite powder, sandust, and nano-grain alloy powder.

### TECHNICAL FIELD

The present invention relates to an injection-molding-type magnetic field shielding member and a wireless power reception module including the same.

### BACKGROUND ART

Wireless power transmission technology is advantageous in terms of user convenience as it does not require a separate wired cable during charging. Accordingly, the wireless power transmission technology is widely used as a method for charging batteries in various electronic devices.

Battery charging using such wireless power transmission can satisfy the required charging efficiency only when the wireless power transmission module and the wireless power reception module are aligned with each other.

As part of this, both the wireless power transmission module and the wireless power reception module are configured to arrange permanent magnets for alignment at the central part of their respective antennas. Accordingly, the wireless power transmission module and the wireless power reception module may maintain an aligned state with each other using the direct current magnetic field generated from the permanent magnets for alignment.

However, when permanent magnets are arranged around the antenna, there is an issue where the charging efficiency decreases due to the influence of the permanent magnets.

To solve this, the shielding members applied to both the wireless power transmission module and the wireless power reception module reduce the influence of the permanent magnets by forming accommodation grooves to house the antennas.

However, when accommodation grooves are formed in the shielding member, the portion that surrounds the sides of the antenna while defining the accommodation groove inevitably protrudes from the flat portion by a predetermined height.

Accordingly, when the shielding member is made of a brittle sintered ferrite, the portion protruding by a predetermined height from the flat portion to surround the sides of the antenna while defining the accommodation groove becomes highly vulnerable to external impact.

As a result, when the portion surrounding the sides of the antenna while defining the accommodation groove falls off or separates due to impact during a drop test, the wireless power transmission module and the wireless power reception module, each with the aforementioned shielding member applied, may fail to pass quality certification.

Further, when the shielding member including the accommodation groove is made of a sintered ferrite material, the portion protruding by a predetermined height from the flat portion to define the accommodation groove not only has a size smaller than the flat portion but also has a very thin thickness of 3 mm or less. As a result, deformation such as warping may occur during the sintering process.

As a result, the accommodation groove formed in the shielding member may have a size different from the initial design, leading to a tolerance issue.

### DISCLOSURE

### Technical Problem

The present invention has been made in an effort in consideration of the aforementioned, and an object of the present invention is to provide an injection-molding-type magnetic field shielding member and a wireless power reception module including the same, which can improve the problem of a protruding portion being damaged by impact, even when the shielding member includes the protruding portion.

### Technical Solution

To achieve the aforementioned objects, the present invention is directed to providing an injection-molding-type magnetic field shielding member, including: a base part including an arrangement hole formed to penetrate and have a predetermined area at a center thereof; a ring-shaped first shielding part formed to protrude from the base part by a predetermined height along an edge of the arrangement hole; and an antenna accommodation part defined by one surface of the first shielding part and one surface of the base part, and formed on one surface of the base part along a circumferential direction of the first shielding part, in which the base part and the first shielding part are integrally formed through injection molding using any one material of ferrite powder, sandust, or nano-grain alloy powder.

In addition, the antenna accommodation part may have a bottom surface formed as a sloped surface inclined at a predetermined angle.

In addition, the injection-molding-type magnetic field shielding member may further include a ring-shaped second shielding part formed to protrude from the base part by a predetermined height in the same direction as the first shielding part along an edge of the base part, in which the base part, first shielding part, and second shielding part may be integrally formed through injection molding using any one material of ferrite powder, sandust, or nano-grain alloy powder.

In this case, a width of the first shielding part may be formed to be the same as or wider than a width of the second shielding part.

In addition, a protrusion height of the first shielding part protruding from one surface of the base part may be the same as or greater than a protrusion height of the second shielding part protruding from one surface of the base part.

In addition, the arrangement hole may be a space for accommodating permanent magnets for alignment.

Meanwhile, the present invention may include: a wireless power reception antenna configured to receive wireless power; permanent magnets for alignment arranged at a center of the wireless power reception antenna; and a shielding member configured to shield a magnetic field, in which the shielding member may be the aforementioned injection-molding-type magnetic field shielding member, the wireless power reception antenna may be arranged in the antenna accommodation part, and the permanent magnets for alignment may be arranged in the arrangement hole.

### Advantageous Effects

According to the present invention, even when the shielding member includes a protruding portion, the problem of the protruding portion being damaged by impact is improved, thereby resolving the quality certification issue.

### DESCRIPTION OF DRAWINGS

FIG. 1 is a view illustrating an injection-molding-type magnetic field shielding member according to one embodiment of the present invention,

FIG. 2 is a cross-sectional view taken along line A-A of FIG. 1,

FIG. 3 is a view illustrating a modified example of FIG. 2,

FIG. 4 is a view illustrating an injection-molding-type magnetic field shielding member according to another embodiment of the present invention,

FIG. 5 is a cross-sectional view taken along line B-B of FIG. 4,

FIG. 6 is a view illustrating a modified example of FIG. 5,

FIG. 7 is a view illustrating a wireless power reception module to which the injection-molding-type magnetic field shielding member of FIG. 2 is applied,

FIG. 8 is a view illustrating a wireless power reception module to which the injection-molding-type magnetic field shielding member of FIG. 3 is applied,

FIG. 9 is a view illustrating a wireless power reception module to which the injection-molding-type magnetic field shielding member of FIG. 5 is applied,

FIG. 10 is a view illustrating a wireless power reception module to which the injection-molding-type magnetic field shielding member of FIG. 6 is applied, and

FIG. 11 is a view illustrating the arrangement relationship between the wireless power reception module of FIG. 10 and the wireless power transmission module.

### BEST MODE

Hereinafter, an embodiment of the present invention will be described in detail with reference to the accompanying drawings so that those skilled in the technical field to which the present invention pertains may easily carry out the embodiment. The present disclosure may be implemented in various different ways, and is not limited to the embodiments described herein. In the drawings, a part irrelevant to the description will be omitted to clearly describe the present disclosure, and the same or similar constituent elements will be designated by the same reference numerals throughout the specification.

Terms or words used in the specification and the claims should not be interpreted as being limited to a general or dictionary meaning and should be interpreted as a meaning and a concept which conform to the technical spirit of the present invention based on a principle that an inventor can appropriately define a concept of a term in order to describe his/her own invention by the best method.

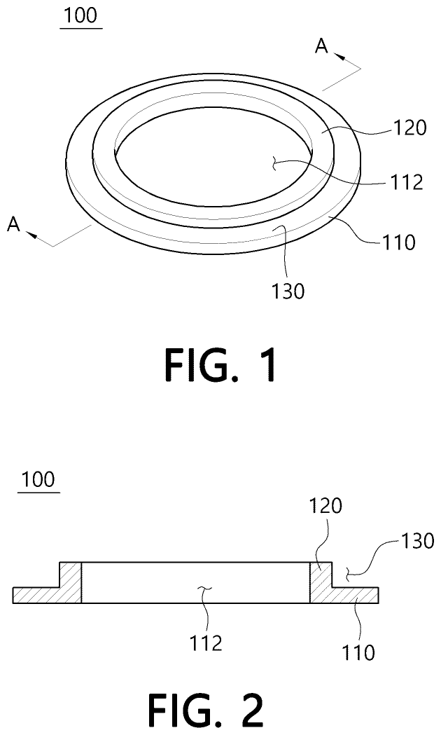

In addition, the “upper surface” used in this specification and claims may refer to a surface viewed from the upper part based on FIG. 1, the “lower surface” may refer to a surface viewed from the lower part based on FIG. 1, and the “side part” and “side surface” may refer to a surface viewed from the left or right side based on FIG. 2. Further, the “thickness direction” and “height direction” used in this specification and claims may refer to the direction parallel to the direction from the upper surface and the lower surface, or from the lower surface to the upper surface based on FIG. 1. The “width direction” may refer to the direction parallel to the direction from the left side to the right side or from the right side to the left side based on FIG. 2.

The injection-molding-type magnetic field shielding member 100, 100′, 200, or 200′ according to one embodiment of the present invention can prevent damage caused by external impact by improving the brittleness of the material itself, compared to conventional shielding members made of sintered ferrite such as Mn—Zn ferrite or Ni—Zn ferrite.

In addition, the injection-molding-type magnetic field shielding member 100, 100′, 200, or 200′ according to one embodiment of the present invention can be implemented at a relatively lower cost compared to conventional shielding members made of sintered ferrite such as Mn—Zn ferrite or Ni—Zn ferrite, thereby reducing production costs and securing price competitiveness.

Further, the injection-molding-type magnetic field shielding member 100, 100′, 200, or 200′ according to one embodiment of the present invention can prevent the deterioration of antenna performance caused by the direct current magnetic field generated by the permanent magnets for alignment 320, even when the permanent magnets for alignment 320 are arranged at the central part.

To this end, the injection-molding-type magnetic field shielding member 100, 100′, 200, or 200′ according to one embodiment of the present invention may include a base part 110, a first shielding part 120, and an antenna accommodation part 130, as illustrated in FIG. 1 to FIG. 6.

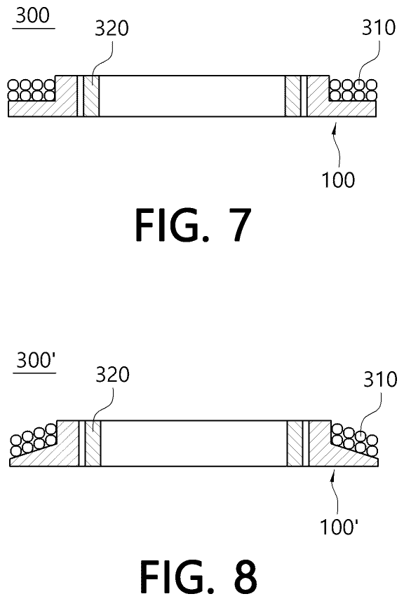

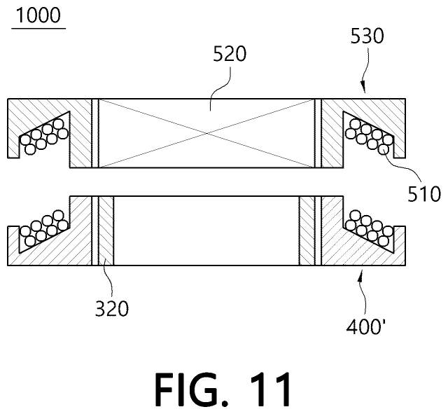

The base part 110 may shield the magnetic field generated by a wireless power transmission antenna (see 510 in FIG. 11) or a wireless power reception antenna (see 310 in FIG. 7), while also increasing the magnetic flux density in the required direction, thereby enhancing the performance of the wireless power transmission antenna operating in a predetermined frequency band.

Here, the wireless power transmission antenna may be a flat coil with a plurality of turns wound in one direction, and the conductive member may be a known Litz wire.

To this end, the base part 110 may be made of a material that has magnetic properties.

For example, the base part 110 may be formed using any one material of ferrite powder, sandust, or nano-grain alloy powder.

In such cases, the ferrite powder may be sintered, and the sandust or nano-grain alloy powder may be heat-treated.

In this case, the base part 110 may include an arrangement hole 112 for arranging the permanent magnets for alignment 320.

Here, the permanent magnets for alignment 320, when the magnetic field shielding member 100, 100′, 200, or 200′ according to one embodiment of the present invention is applied to the wireless power reception module 300, 300′, 400, or 400′, may be provided in a ring shape, but this is not limited thereto, and they may also be provided in a disc or cylindrical shape.

For example, the arrangement hole 112 may be formed to penetrate the base part 110 with a predetermined area.

Accordingly, the permanent magnets for alignment 320 may be inserted into the arrangement hole 112, and the permanent magnets for alignment 320 may align the other module to the correct position through interaction with the permanent magnets for alignment (see 520 in FIG. 11) provided in the corresponding other module during wireless power transmission.

The first shielding part 120 may be formed to protrude from the base part 110 by a predetermined height along the edge of the arrangement hole 112.

For example, the first shielding part 120 may be provided in a ring shape, being formed to protrude from one surface of the base part 110 to surround the circumference of the arrangement hole 112.

The first shielding part 120, like the base part 110, may be made of a material that has magnetic properties.

For example, the first shielding part 120 may be formed using any one material of ferrite powder, sandust, or nano-grain alloy powder.

In such cases, the ferrite powder may be sintered, and the sandust or nano-grain alloy powder may be heat-treated.

Therefore, the first shielding part 120 may perform a function as a blocking wall that blocks the direct current magnetic field generated by the permanent magnets for alignment 320 inserted into the arrangement hole 112.

In other words, the injection-molding-type magnetic field shielding member 100, 100′, 200, or 200′ according to one embodiment of the present invention can shield the magnetic field generated by the permanent magnets for alignment 320, even when the permanent magnets for alignment 320 are inserted into the arrangement hole 112, through the first shielding part 120.

As a result, the injection-molding-type magnetic field shielding member 100, 100′, 200, or 200′ according to one embodiment of the present invention can prevent the deterioration of the performance of the wireless power transmission antenna caused by the direct current magnetic field generated by the permanent magnets for alignment 320, even when the permanent magnets for alignment 320 are inserted into the arrangement hole 112.

In this case, the first shielding part 120 may be integrally formed with the base part 110.

That is, as described above, the first shielding part 120 and the base part 110 may be integrally formed using any one material of ferrite powder, sandust, or nano-grain alloy powder through injection molding.

For example, the first shielding part 120 and the base part 110 may be made of the same material, and the first shielding part 120 and the base part 110 may be integrally formed by mixing any one material of ferrite powder, sandust, or nano-grain alloy powder with a binder, followed by pressure molding using a mold.

In addition, the binder may include a mixture of materials such as nylon and PPS.

Accordingly, the injection-molding-type magnetic field shielding member 100, 100′, 200, or 200′ according to one embodiment of the present invention can improve brittleness compared to conventional shielding members made of sintered ferrite, as the sintering process is omitted, and it can fundamentally prevent deformation issues such as warping that may occur during the sintering process.

As a result, the injection-molding-type magnetic field shielding member 100, 100′, 200, or 200′ according to one embodiment of the present invention can improve the problem of the first shielding part 120, which protrudes from the base part 110 to shield the direct current magnetic field generated by the permanent magnets for alignment 320, being damaged by impact even if the first shielding part 120, which protrudes from the base part 110 by a predetermined height is included. Therefore, the injection-molding-type magnetic field shielding member 100, 100′, 200, or 200′ according to one embodiment of the present invention can resolve quality certification issues caused by damage.

In addition, the injection-molding-type magnetic field shielding member 100, 100′, 200, or 200′ according to one embodiment of the present invention can fundamentally prevent deformation issues, such as warping, that may occur during the sintering process or heat treatment process, because the first shielding part 120 and base part 110 are integrally formed through pressure molding using a mold. Therefore, the injection-molding-type magnetic field shielding member 100, 100′, 200, or 200′ according to one embodiment of the present invention can significantly reduce the possibility of tolerance occurrence issues caused by deformation.

The antenna accommodation part 130 may be formed on one surface of the base part 110.

That is, as described above, when the first shielding part 120 is formed to protrude by a predetermined height from one surface of the base part 110, the antenna accommodation part 130 may be defined by one surface of the first shielding part 120 and one surface of the base part 110, and may be formed along the circumferential direction of the first shielding part 120, which is shaped in a ring.

Specifically, the antenna accommodation part 130 may be defined by the upper surface of the base part 110 and the side surface of the first shielding part 120, based on FIG. 2. The antenna accommodation part 130 may be formed on the upper surface of the base part 110 along the outer circumferential surface of the first shielding part 120.

The antenna accommodation part 130, as described, may be a space where the wireless power transmission antenna is arranged and may accommodate the thickness of the wireless power transmission antenna.

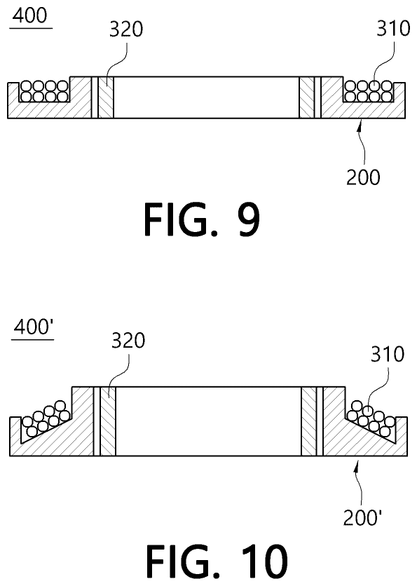

For example, as illustrated in FIG. 7 to FIG. 10, when the wireless power transmission antenna is provided as a flat coil, the coil body of the flat coil may be arranged in the antenna accommodation part 130, and the thickness of the flat coil arranged in the antenna accommodation part 130 may be accommodated by a protrusion height h1 of the first shielding part.

Here, the protrusion height h1 of the first shielding part, which protrudes by a predetermined height from one surface of the base part 110, may have a size equal to or greater than the thickness of the flat coil.

Accordingly, when the permanent magnets for alignment 320 are arranged in the arrangement hole 112 and the flat coil is arranged in the antenna accommodation part 130, the direct current magnetic field generated by the permanent magnets for alignment 320 may be blocked through the first shielding part 120, thereby preventing the deterioration of the flat coil's performance due to the direct current magnetic field.

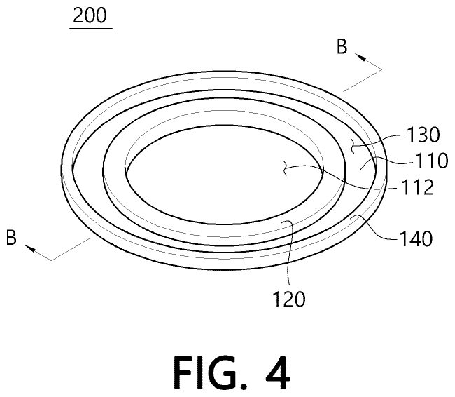

Meanwhile, the injection-molding-type magnetic field shielding member 200 or 200′ according to one embodiment of the present invention, as illustrated in FIG. 4 to FIG. 6, may further include a ring-shaped second shielding part 140, which is formed to protrude by a predetermined height from the edge of the base part 110 in the same direction as the first shielding part 120 along the edge of the base part 110, together with the first shielding part 120 that is formed to protrude from the base part 110 by a predetermined height along the edge of the arrangement hole 112.

In such a case, the antenna accommodation part 130, formed on one surface of the base part 110, may be formed in the shape of a groove with an open top.

That is, as described above, when the first shielding part 120 and the second shielding part 140 are each formed to protrude by a predetermined height from one surface of the base part 110, the antenna accommodation part 130 may be defined by one surface of the first shielding part 120, one surface of the base part 110, and one surface of the second shielding part 140, and may be formed on one surface of the base part 110 to be positioned between the first shielding part 120 and the second shielding part 140, which are formed in a ring shape.

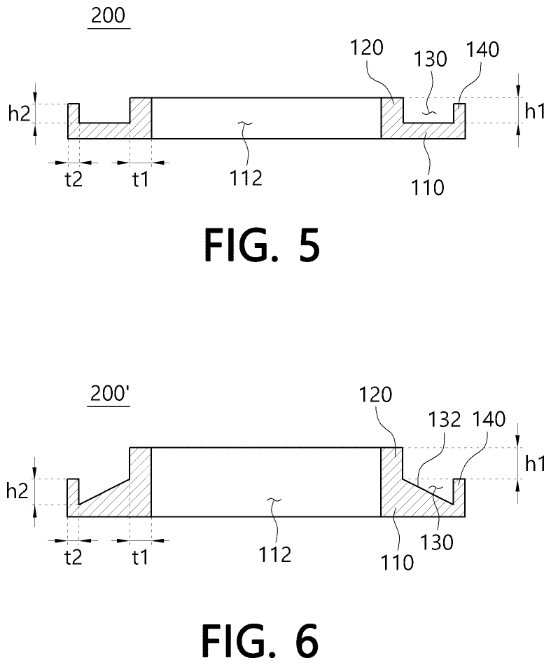

Specifically, the antenna accommodation part 130, based on FIG. 5, may be defined by the upper surface of the base part 110, the outer surface of the first shielding part 120, and the inner surface of the second shielding part 140. The antenna accommodation part 130 may be formed on the upper surface of the base part 110 along the outer circumferential surface of the first shielding part 120 and the inner circumferential surface of the second shielding part 140.

Accordingly, when the flat coil is arranged in the antenna accommodation part 130, the inner edge of the flat coil may be surrounded by the outer circumferential surface of the first shielding part 120, and the outer edge of the flat coil may be surrounded by the inner circumferential surface of the second shielding part 140.

In this case, the second shielding part 140 may be made of a material that has magnetic properties, similar to the base part 110 and the first shielding part 120.

For example, the second shielding part 140 may be formed using any one material of ferrite powder, sandust, or nano-grain alloy powder.

In such cases, the ferrite powder may be sintered, and the sandust or nano-grain alloy powder may be heat-treated.

Therefore, the second shielding part 140, like the base part 110 and the first shielding part 120, may shield the magnetic field.

Additionally, the second shielding part 140 may be integrally formed with the base part 110.

That is, the second shielding part 140 and the base part 110 may be integrally formed using any one material of ferrite powder, sandust, or nano-grain alloy powder through injection molding.

For example, the first shielding part 120, the second shielding part 140, and the base part 110 may be made of the same material as each other, and the first shielding part 120, the second shielding part 140, and the base part 110 may be integrally formed by mixing any one material of ferrite powder, sandust, or nano-grain alloy powder with a binder, followed by pressure molding using a mold.

In addition, the binder may include a mixture of materials such as nylon and PPS.

Accordingly, the injection-molding-type magnetic field shielding member 200 or 200′ according to one embodiment of the present invention can improve brittleness compared to conventional shielding members made of sintered ferrite, as the sintering process is omitted, and it can fundamentally prevent deformation issues such as warping that may occur during the sintering process.

As a result, the injection-molding-type magnetic field shielding member 200 or 200′ according to one embodiment of the present invention can improve the problem of the first shielding part 120 and the second shielding part 140, which protrude from the base part 110, being damaged by impact, even if the first shielding part 120 and the second shielding part 140, which protrude by a predetermined height from the base part 110, are included. Therefore, the injection-molding-type magnetic field shielding member 200 or 200′ according to one embodiment of the present invention can resolve quality certification issues caused by damage.

Additionally, the injection-molding-type magnetic field shielding member 200 or 200′ according to one embodiment of the present invention can fundamentally prevent deformation issues, such as warping, that may occur during the sintering process or heat treatment process, because the first shielding part 120, the second shielding part 140, and the base part 110 are integrally formed through pressure molding using a mold. Therefore, the injection-molding-type magnetic field shielding member 200 or 200′ according to one embodiment of the present invention can significantly reduce the possibility of tolerance occurrence issues caused by deformation.

Further, the injection-molding-type magnetic field shielding member 200 or 200′ according to one embodiment of the present invention can significantly reduce the possibility of tolerance occurrence issues by preventing deformation problems, such as warping, that may occur during the sintering process or heat treatment process. This is possible because the antenna accommodation part 130, even if it has a complex shape such as a roughly ‘L’ shaped cross-section with an open top, may be integrally formed through pressure molding using a mold.

In this case, the first shielding part 120 and the second shielding part 140 may each be formed in a ring shape with a closed-loop configuration, as described above, and the first shielding part 120 may be provided to have a relatively smaller size than the second shielding part 140.

In addition, as illustrated in FIG. 5 and FIG. 6, the first shielding part may be provided to have a width t1 equal to or wider than a width t2 of the second shielding part, and a protrusion height h1 of the first shielding part that protrudes from one surface of the base part 110 may be formed to have the same size as a protrusion height h2 of the second shielding part that protrudes from one surface of the base part 110, or to have a greater size than the protrusion height h2 of the second shielding part that protrudes from one surface of the base part 110.

Meanwhile, in the injection-molding-type magnetic field shielding member 100′ or 200′ according to one embodiment of the present invention, a bottom surface 132 of the antenna accommodation part may be formed as a horizontal surface, but it may also be formed as a sloped surface inclined at a predetermined angle.

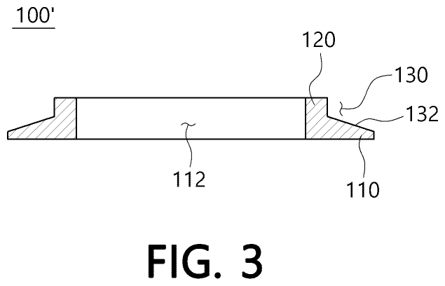

For example, as illustrated in FIG. 3 and FIG. 6, the bottom surface 132 of the antenna accommodation part 130 may be formed with a slope such that the thickness of the base part 110 gradually becomes thinner from the first shielding part 120 toward the second shielding part 140.

This allows, when the injection-molding-type magnetic field shielding member 100′ or 200′ according to one embodiment of the present invention is implemented as a wireless power transmission module, the wireless power transmission antenna arranged along the sloped surface of the antenna accommodation part 130 to be arranged in such a way that the central part has a convex shape on one side.

Accordingly, the wireless power transmission antenna can further increase the magnetic flux density and enhance wireless power transmission efficiency by changing its shape to have a convex central part.

Meanwhile, the injection-molding-type magnetic field shielding member 100, 100′, 200, or 200′ according to one embodiment of the present invention may be implemented as a wireless power transmission module.

For example, the injection-molding-type magnetic field shielding member 100, 100′, 200, or 200′ according to one embodiment of the present invention may be implemented as a wireless power reception module 300, 300′, 400, or 400′ as illustrated in FIG. 7 to FIG. 10, and the wireless power reception module 300, 300′, 400, or 400′ may be applied to a smartwatch.

That is, the wireless power reception module 300, 300′, 400, or 400′ may include a wireless power reception antenna 310 for receiving wireless power, permanent magnets for alignment 320 arranged at the center of the wireless power reception antenna 310, and a shielding member for shielding the magnetic field. The shielding member may be the aforementioned injection-molding-type magnetic field shielding member 100, 100′, 200, or 200′.

In this case, the wireless power reception antenna 310 may be a flat coil arranged in the antenna accommodation part 130, and the permanent magnets for alignment 320 may be provided in a ring shape and arranged in the arrangement hole 112.

Here, the flat coil may be formed by winding a conductive member with a predetermined length a plurality of turns in a clockwise or counterclockwise direction to form a coil body, and the coil body may include a hollow portion formed with a predetermined area at the center. Additionally, the coil body may be formed as a single layer or multi-layer.

Additionally, the conductive member forming the coil body of the flat coil may be composed of a plurality of wires having a predetermined wire diameter, and the plurality of wires may be insulated with a coating material that has insulating properties on their surface. The plurality of wires may be twisted together along the length direction or arranged in parallel with each other along one direction.

Further, as illustrated in FIG. 11, the wireless power reception module 300, 300′, 400, or 400′ may receive wireless power transmitted from a wireless power transmission module provided in a wearable wireless charger, such as a smartwatch.

In this case, when the antenna accommodation part 130 in the injection-molding-type magnetic field shielding member 100′ or 200′ includes a sloped surface, the flat coil, based on FIG. 8 and FIG. 10, may be formed such that its central part has a convex shape toward the top.

In this case, the wireless power transmission module may include a wireless power transmission antenna 510 provided as a flat coil, permanent magnets for alignment 520 arranged at the center of the wireless power transmission antenna 510, and a shielding member 530 for shielding the magnetic field. The wireless power transmission antenna 510 may be provided, based on FIG. 11, to have a central part that is convex downward, allowing it to face the wireless power reception antenna 310 at a predetermined interval.

Here, the wireless power transmission antenna 510 may be a flat coil with a conductive member wound a plurality of turns in one direction, and the flat coil may be formed by winding a conductive member with a predetermined length a plurality of turns in a clockwise or counterclockwise direction to form the coil body. Additionally, the coil body may include a hollow portion formed with a predetermined area at the center, and the coil body may be formed as a single layer or multi-layer.

Additionally, the conductive member forming the coil body of the flat coil may be composed of a plurality of wires having a predetermined wire diameter, and the plurality of wires may be insulated with a coating material that has insulating properties on their surface. The plurality of wires may be twisted together along the length direction or arranged in parallel with each other along one direction.

Accordingly, the wireless power transmitted from the wireless power transmission antenna 510 may be smoothly transmitted toward the wireless power reception antenna 310 arranged on the sloped surface.

Meanwhile, although the injection-molding-type magnetic field shielding member 100, 100′, 200, or 200′ according to one embodiment of the present invention has been described as being applied to the wireless power reception module 300, 300′, 400, or 400′, when the wireless power reception antenna 310 is replaced by a wireless power transmission antenna, the aforementioned wireless power reception module 300, 300′, 400, or 400′ may be implemented as a wireless power transmission module embedded in a wireless charger.

Additionally, although the wireless power reception antenna 310 arranged in the antenna accommodation part 130 has been described as being provided as a flat coil in the above explanation, this is not limiting, and it may also be provided as an antenna pattern formed on a circuit board.

While the embodiments of the present invention have been described above, the spirit of the present invention is not limited to the embodiments presented in the present specification, those skilled in the art, who understand the spirit of the present invention, may easily propose other embodiments by adding, changing, deleting constituent elements within the same spirit and scope of the present invention, and it can be said that the embodiments are also within the spirit and scope of the present invention.

1. An injection-molding-type magnetic field shielding member, comprising:
a base part including an arrangement hole formed to penetrate and have a predetermined area at a center thereof;
a ring-shaped first shielding part formed to protrude from the base part by a predetermined height along an edge of the arrangement hole; and
an antenna accommodation part defined by one surface of the first shielding part and one surface of the base part, and formed on one surface of the base part along a circumferential direction of the first shielding part,
wherein the base part and the first shielding part are integrally formed through injection molding using any one material of ferrite powder, sandust, or nano-grain alloy powder.

2. The injection-molding-type magnetic field shielding member of claim 1, wherein the antenna accommodation part has a bottom surface formed as a sloped surface inclined at a predetermined angle.

3. The injection-molding-type magnetic field shielding member of claim 1, further comprising:
a ring-shaped second shielding part formed to protrude from the base part by a predetermined height in the same direction as the first shielding part along an edge of the base part,
wherein the base part, first shielding part, and second shielding part are integrally formed through injection molding using any one material of ferrite powder, sandust, or nano-grain alloy powder.

4. The injection-molding-type magnetic field shielding member of claim 3, wherein a width of the first shielding part is formed to be the same as or wider than a width of the second shielding part.

5. The injection-molding-type magnetic field shielding member of claim 3, wherein a protrusion height of the first shielding part protruding from one surface of the base part is the same as or greater than a protrusion height of the second shielding part protruding from one surface of the base part.

6. The injection-molding-type magnetic field shielding member of claim 1, wherein the arrangement hole is a space for accommodating permanent magnets for alignment.

7. A wireless power reception module, comprising:
a wireless power reception antenna configured to receive wireless power;
permanent magnets for alignment arranged at a center of the wireless power reception antenna; and
a shielding member configured to shield a magnetic field,
wherein the shielding member includes:
a base part including an arrangement hole formed to penetrate a center thereof through which the permanent magnets for alignment are arranged;
a ring-shaped first shielding part formed to protrude from the base part by a predetermined height along an edge of the arrangement hole; and
an antenna accommodation part defined by one surface of the first shielding part and one surface of the base part, and formed on one surface of the base part along a circumferential direction of the first shielding part to accommodate the wireless power reception antenna, and
wherein the base part and the first shielding part are integrally formed through injection molding using any one material of ferrite powder, sandust, or nano-grain alloy powder.

8. The wireless power reception module of claim 7, wherein the antenna accommodation part has a bottom surface formed as a sloped surface inclined at a predetermined angle.

9. The wireless power reception module of claim 7, wherein the shielding member further includes a ring-shaped second shielding part formed to protrude from the base part by a predetermined height in the same direction as the first shielding part along an edge of the base part, and
wherein the base part, first shielding part, and second shielding part are integrally formed through injection molding using any one material of ferrite powder, sandust, or nano-grain alloy powder.

10. The wireless power reception module of claim 9, wherein a width of the first shielding part is formed to be the same as or wider than a width of the second shielding part.

11. The wireless power reception module of claim 9, wherein a protrusion height of the first shielding part protruding from one surface of the base part is the same as or greater than a protrusion height of the second shielding part protruding from one surface of the base part.

12. The wireless power reception module of claim 7, wherein the arrangement hole is a space for accommodating permanent magnets for alignment.
